(19) United States
(12) Patent Application Publication
(10) Pub. No.: US 2024/0190268 A1
(43) Pub. Date: Jun. 13, 2024

(54) Vehicle

(71) Applicant: TOYOTA JIDOSHA KABUSHIKI KAISHA, Toyota-shi (JP)

(72) Inventors: Jun KOBAYASHI, Obu-shi Aichi-ken (JP); Takahiro OKANO, Chiryu-shi Aichi-ken (JP); Mitsuyoshi OHNO, Miyoshi-shi Aichi-ken (JP); Nobuhiro NAKANO, Nagakute-shi Aichi-ken (JP)

(73) Assignee: TOYOTA JIDOSHA KABUSHIKI KAISHA, Toyota-shi (JP)

(21) Appl. No.: 18/514,398

(22) Filed: Nov. 20, 2023

(30) Foreign Application Priority Data
Dec. 9, 2022 (JP) 2022-197347

(51) Int. Cl. B60L 50/64

(52) U.S. Cl. CPC B60L 50/64

(57) ABSTRACT

A vehicle includes a vehicle body on which a battery is mountable and a battery attachable to and detachable from the vehicle body. The battery includes a battery side connector. The vehicle body includes a vehicle body side connector to be engaged with the battery side connector. The battery side connector is made of a material having a lower hardness than a material constituting the vehicle body side connector.

### CROSS-REFERENCE TO RELATED APPLICATIONS

This nonprovisional application is based on Japanese Patent Application No. 2022-197347 filed on Dec. 9, 2022 with the Japan Patent Office, the entire contents of which are hereby incorporated by reference.

### BACKGROUND

### Field

The present disclosure relates to a vehicle.

### Description of the Background Art

Conventionally, a vehicle in which a battery can be replaced is known. For example, Japanese Patent Application Laid-Open No. 2012-192782 discloses that a portion where a battery is mounted is provided in a lower portion of a vehicle body, and a battery is replaced from below the vehicle body.

### SUMMARY

In the battery electric vehicle described in Japanese Patent Application Laid-Open No. 2012-192782, since the connector on the vehicle body side and the connector on the battery side are rubbed when the battery is replaced, wear of the connector becomes stronger than that of a vehicle of a type in which the battery is charged from a charging port without being replaced. If the contact resistance increases due to wear of the connector on the vehicle body side, sufficient power may not be obtained from the battery.

It is an object of the present disclosure to provide a vehicle capable of reducing wear of a vehicle body side connector.

A vehicle according to one aspect of the present disclosure includes a vehicle body on which a battery is mountable and the battery attachable to and detachable from the vehicle body. The battery includes a battery side connector. The vehicle body includes a vehicle body side connector to be engaged with the battery side connector. The battery side connector is made of a material having a lower hardness than a material constituting the vehicle body side connector.

These and other objects, features, aspects and advantages of the disclosure will become apparent from the following detailed description of the disclosure, which is understood in conjunction with the accompanying drawings.

### BRIEF DESCRIPTION OF THE DRAWINGS

FIG. 1 schematically shows a battery replacement apparatus according to an embodiment of the present disclosure.

FIG. 2 is a perspective view schematically showing a configuration of a battery.

FIG. 3 is a cross-sectional view schematically showing a battery side connector and a vehicle body side connector.

FIG. 4 is a cross-sectional view schematically showing a modified example of the battery side connector and the vehicle body side connector.

### DESCRIPTION OF THE EMBODIMENTS

Hereinafter, embodiments of the present disclosure will be described in detail with reference to the accompanying drawings. In the drawings, the same or corresponding parts are denoted by the same reference numerals, and the description thereof will not be repeated.

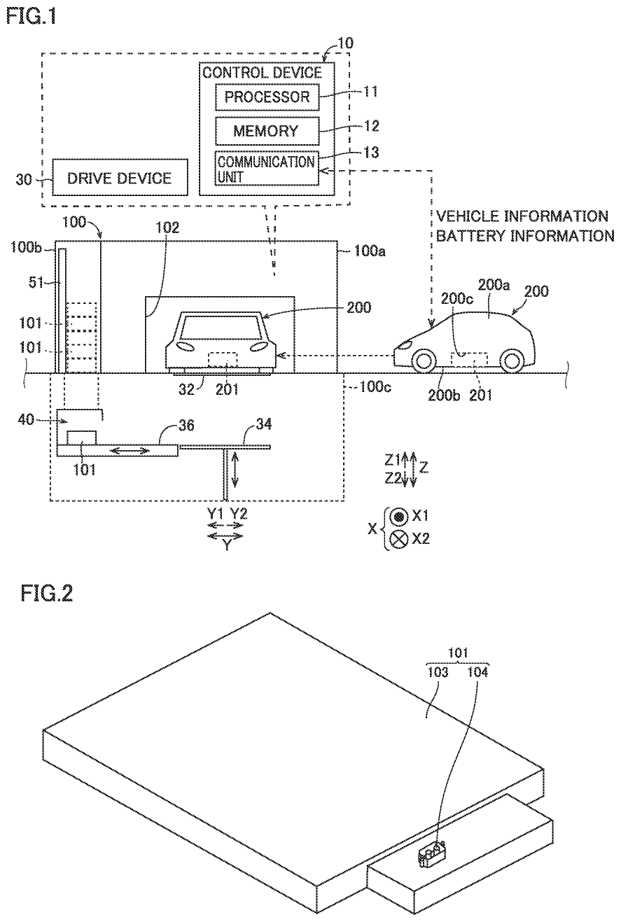

FIG. 1 is a diagram showing a battery replacement apparatus 100 and an electrically powered vehicle 200 according to the present embodiment. The battery replacement apparatus 100 is a device for replacing a battery (used battery) 201 attached to the electrically powered vehicle 200 with a charged battery (new battery) 101. The battery 201 and the battery 101 are examples of the “first battery” and the “second battery” of the present disclosure, respectively.

### (Configuration of Electrically Powered Vehicle)

As shown in FIG. 1, the vehicle body 200a of the electrically powered vehicle 200 has a mounting portion 200c on which the batteries 101 and 201 can be mounted. The mounting portion 200c opens downward. The mounting portion 200c has a shape recessed upward from the lower surface 200b of the vehicle body 200a. The batteries 101 and 201 are attachable to and detachable from the mounting portion 200c. Specifically, the batteries 101 and 201 are fastened to the mounting portion 200c by fastening members such as bolts.

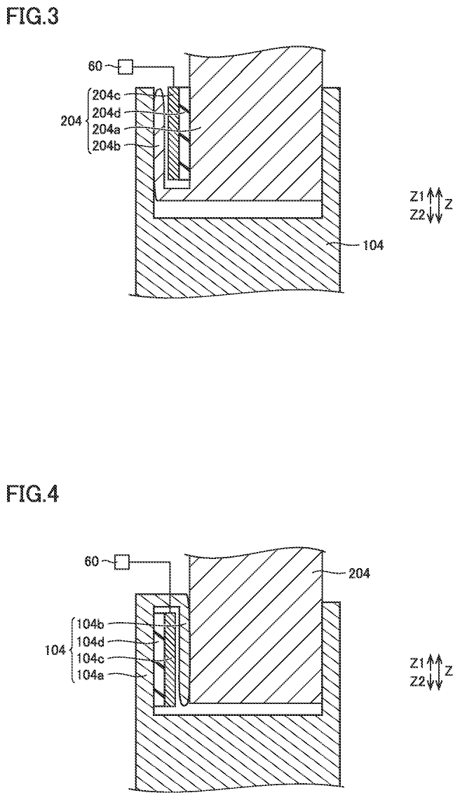

Next, the configuration of the battery will be described with reference to FIGS. 2 and 3. Hereinafter, the charged battery 101 will be described as an example. As shown in FIG. 2, the battery 101 includes a battery main body 103 and a battery side connector 104.

The battery side connector 104 projects upward from the battery main body 103. The battery side connector 104 can be connected to a vehicle body side connector 204 (see FIG. 3). The battery side connector 104 is made of a material having a lower hardness than the material constituting the vehicle body side connector 204. The battery side connector 104 is made of silver or a silver alloy, for example. As shown in FIG. 3, the battery side connector 104 includes a female terminal.

The mounting portion 200c is provided with a vehicle body side connector 204 (see FIG. 3) to be engaged with the battery side connector 104. The vehicle body side connector 204 includes a connector main body 204a, a contact portion 204b, a wear detection terminal 204c, and an insulating member 204d.

The connector main body 204a is formed of a male terminal. The connector main body 204a is formed, for example, in a cylindrical shape.

The contact portion 204b is a portion that contacts the battery side connector 104. The contact portion 204b is connected to the connector main body 204a. The connector main body 204a and the contact portion 204b are made of copper, for example. A gap is formed between the connector main body 204a and the contact portion 204b in a direction orthogonal to the axial direction of the connector main body 204a.

The wear detection terminal 204c is disposed inside the contact portion 204b. Specifically, the wear detection terminal 204c is disposed in the gap. The wear detection terminal 204c is insulated from the connector main body 204a and the contact portion 204b. The wear detection terminal 204c contacts the battery side connector 104 when the contact portion 204b is worn.

The insulating member 204d is provided between the connector main body 204a and the wear detection terminal 204c. The insulating member 204d insulates the wear detection terminal 204c from the connector main body 204a.

As shown in FIG. 3, a notification unit 60 is connected to the wear detection terminal 204c. When the battery side connector 104 comes into contact with the wear detection terminal 204c due to wear of the contact portion 204b, the notification unit 60 transmits a wear detection signal. The wear detection signal is used to turn on a display device such as an LED, to emit an alarm sound, or the like.

### (Configuration of Battery Switching Device)

Next, the battery replacement apparatus 100 will be described. As shown in FIG. 1, the battery replacement apparatus 100 includes a battery replacement station 100a, a storage box 100b, and an underfloor area 100c.

The battery replacement station 100a is a station in which the battery 201 is detached from the electrically powered vehicle 200 and the battery 101 is attached to the electrically powered vehicle 200. The battery replacement station 100a is provided with an entrance/exit 102 for the electrically powered vehicle 200 to enter/exit.

The storage box 100b stores the charged battery 101. The storage box 100b is provided in parallel with the battery replacement station 100a. A charging facility 51 capable of charging the battery 201 removed from the electrically powered vehicle 200 is provided in the storage box 100b. The battery 201 is charged by the charging facility 51 in the storage box 100b. The battery 101 charged in the storage box 100b, that is, the charged battery 101 is moved to the temporary place 40 provided in the underfloor area 100c, and then conveyed to the electrically powered vehicle 200.

The underfloor area 100c is provided below the battery replacement station 100a and the storage box 100b. The underfloor area 100c is provided with a battery mounting table 34, an elevation unit, a transport unit 36, and a temporary place 40, which will be described later.

The battery replacement apparatus 100 includes a control device 10 and a drive device 30.

The control device 10 includes a processor 11, a memory 12, and a communication unit 13. The memory 12 stores, in addition to a program executed by the processor 11, information (e.g., map, formula, and various parameters) used by the program. As will be described in detail later, the processor 11 controls the drive device 30.

The communication unit 13 includes various communication I/Fs. The processor 11 controls the communication unit 13. The communication unit 13 communicates with a DCM or the like of the electrically powered vehicle 200. The communication unit 13 and the electrically powered vehicle 200 can perform bidirectional communication. The communication unit 13 may communicate with a mobile terminal or the like possessed by the user of the electrically powered vehicle 200.

The battery replacement station 100a is provided with a vehicle stop region (not shown). When the user performs an operation for instructing the start of the battery replacement operation in a navigation system (not shown) of the electrically powered vehicle 200 in a state where the electrically powered vehicle 200 is stopped in the vehicle stop region, the communication unit 13 receives an instruction signal for starting the battery replacement operation from the electrically powered vehicle 200. The processor 11 starts the control of the battery replacement operation based on the reception of the instruction signal by the communication unit 13. The electrically powered vehicle 200 stops in the vehicle stop region such that the front-rear direction is the X direction and the left-right direction is the Y direction.

The drive device 30 includes a shutter 32, a battery mounting table 34, and a transport unit 36.

The shutter 32 is provided in the vehicle stop region. The shutter 32 is configured to be able to open and close an opening formed in a floor surface of the vehicle stop region. The shutter 32 can be switched between a state in which the opening is opened and a state in which the opening is closed.

The battery mounting table 34 is disposed below the battery replacement station 100a, more specifically, below the opening of the shutter 32. The battery mounting table 34 can mount the batteries 101 and 201 and can move in the vertical direction.

The transport unit 36 transports the battery 101 stored in the storage box 100b toward the battery mounting table 34. Specifically, in the underfloor area 100c, a temporary place 40 for temporarily placing the charged battery 101 stored in the storage box 100b is provided, and the transport unit 36 can transport the battery 101 from the temporary place 40 toward the battery mounting table 34. The transport unit 36 may be of a belt conveyor type, for example.

### (Battery Replacement Method)

Next, a battery replacement method using the battery replacement apparatus 100 will be described.

### [Transmission of Vehicle Information and the Like: Electrically Powered Vehicle]

First, the electrically powered vehicle 200 transmits information about the electrically powered vehicle 200 and information about the battery 201 to the communication unit 13 of the battery replacement apparatus 100. For example, when an operation of transmitting the above information is performed in a navigation system (not shown) of the electrically powered vehicle 200, the above information is transmitted to the communication unit 13. The electrically powered vehicle 200 transmits the above information before entering the battery replacement apparatus 100. The above information may be transmitted after the electrically powered vehicle 200 has entered the battery replacement apparatus 100.

### [Acquisition of Vehicle Information and the Like: Battery Replacement Apparatus]

Next, the communication unit 13 of the battery replacement apparatus 100 acquires information on the electrically powered vehicle 200 and information on the battery 201 transmitted from the electrically powered vehicle 200 by communication. The acquired information is stored in the memory 12 (see FIG. 1).

The communication unit 13 may also acquire information on the capacity (charge capacity) of the battery 201 and the SOC (State Of Charge) of the battery 201.

### [Transmission of an Instruction Signal for Battery Replacement Work: Electrically Powered Vehicle]

Next, the electrically powered vehicle 200 stopped in the vehicle stop region transmits an instruction signal for starting the battery replacement operation to the communication unit 13.

### [Receiving an Instruction Signal for a Battery Replacement Operation:]

Next, the communication unit 13 receives the instruction signal transmitted from the electrically powered vehicle 200. After receiving the instruction signal, the processor 11 may transmit an instruction message or the like for turning off the ignition power supply to the user of the electrically powered vehicle 200 through the communication unit 13.

### [Control of Vehicle Position:]

Next, the processor 11 adjusts the position of the electrically powered vehicle 200 based on the information (vehicle information and battery information) acquired through the communication unit 13.

Thus, the position and orientation of the vehicle body 200a in the horizontal direction are adjusted, and the position and orientation of the battery 201 in the horizontal direction are adjusted. As a result, the battery 201 is moved to a predetermined position above the opening of the shutter 32.

[Removal of the Battery after Use: Battery Replacement Apparatus]

Next, the battery 201 after use is detached from the vehicle body 200a of the electrically powered vehicle 200. First, the processor 11 opens the shutter 32 and raises the battery mounting table 34. As a result, the battery mounting table 34 is positioned with respect to the electrically powered vehicle 200 (battery 201).

Next, the processor 11 drives (rotates) an unlocking tool (not shown) for rotating a fastening member for connecting the battery to the mounting portion 200c. Thereby, the fastening member is unlocked. As a result, the battery 201 is detached from the vehicle body 200a and mounted on the battery mounting table 34.

[Transportation of the Battery after Use to the Storage: Battery Replacement Apparatus]

Next, the battery 201 removed from the vehicle body 200a is conveyed to the storage box 100b. First, the processor 11 lowers the battery mounting table 34 on which the battery 201 is mounted to the height position of the transport unit 36. Subsequently, the processor 11 drives a roller portion (not shown) of the battery mounting table 34 so that the battery 201 moves in the storage direction (Y1 direction) on the battery mounting table 34. Thus, the battery 201 mounted on the battery mounting table 34 moves from the battery mounting table 34 to the transport unit 36. The battery 201 is transported to the temporary place 40 by the transport unit 36, and then stored in the storage box 100b.

### [Transporting the Charged Battery to a Battery Mounting Table:]

Next, the processor 11 conveys the charged battery 101 stored in the storage box 100b to the battery mounting table 34. Specifically, after the processor 11 conveys the battery 101 from the storage box 100b to the temporary place 40 in the underfloor area 100c, the processor 11 moves the battery 101 from the temporary place 40 to the battery mounting table 34 by driving the transport unit 36 in the conveying direction (Y2 direction). When the battery 101 moves from the transport unit 36 to the battery mounting table 34, the processor 11 drives the roller section so that the battery 101 moves on the battery mounting table 34 along the conveying direction. As a result, the battery 101 stops at a predetermined position on the battery mounting table 34.

### [Mounting of Charged Battery: Battery Replacement Apparatus]

Next, the processor 11 performs control of attaching the charged battery 101 to the vehicle body 200a. Specifically, the processor 11 raises the battery mounting table 34. In this state, the processor 11 drives (rotates) the locking tool. Thereby, the fastening member is locked. When it is detected that all the fastening members are locked, the vehicle body side connector 204 and the battery side connector 104 are locked. As a result, the mounting of the charged battery 101 to the vehicle body 200a is completed.

### [Retraction of the Battery Mounting Table and the Elevation Unit: Battery Replacement Apparatus]

Next, the processor 11 lowers the battery mounting table 34 and retracts the battery mounting table 34 from the electrically powered vehicle 200. Thereafter, the processor 11 closes the shutter 32.

### [Notification of Completion of Battery Replacement Work: Battery Replacement Apparatus]

Next, the processor 11 notifies the electrically powered vehicle 200 of the completion of the battery replacement operation through the communication unit 13.

### [Receipt of the Battery Replacement Work Completion Notification: Electrically Powered Vehicle]

Then, the electrically powered vehicle 200 receives the notification transmitted from the communication unit 13 of the battery replacement apparatus 100. Thus, the electrically powered vehicle 200 is brought into a state in which the ignition power supply can be turned on. Thereafter, the process ends.

In the above embodiment, the position of the drive device 30 is adjusted based on the information about each of the electrically powered vehicle 200 and the battery 201, but the present disclosure is not limited thereto. The position of the drive device 30 may be adjusted based on information about either the electrically powered vehicle 200 or the battery 201.

As described above, in the electrically powered vehicle 200 according to the present embodiment, since the battery side connector 104 is made of a material having a hardness lower than that of the material forming the vehicle body side connector 204, wear of the vehicle body side connector 204 is reduced when the battery 101 is attached to the mounting portion 200c and when the battery 201 is detached from the mounting portion 200c.

In the above embodiment, as shown in FIG. 4, the battery side connector 104 may include a connector main body 104a, a contact portion 104b, a wear detection terminal 104c, and an insulating member 104d. The configurations of the contact portion 104b, the wear detection terminal 104c, and the insulating member 104d are the same as the configurations of the contact portion 204b, the wear detection terminal 204c, and the insulating member 204d in the above embodiment. The structure of the battery side connector 104 shown in FIG. 4 may be applied to the above embodiment.

In addition, an evaluation jig having a shape corresponding to the shape of the battery side connector 104 may be provided in the battery replacement station 100a or the underfloor area 100c. In this case, when the battery 201 is detached, the evaluation jig is connected to the vehicle body side connector 204, and the contact resistance between the evaluation jig and the vehicle body side connector 204 is measured. At this time, the insertion stroke of the evaluation jig is set to be constant.

When the contact resistance is equal to or greater than the predetermined value, it is determined that the contact resistance increases due to wear of the vehicle body side connector 204. Therefore, the vehicle body side connector 204 is replaced.

Similarly to the above, an evaluation jig having a shape corresponding to the vehicle body side connector 204 may be provided, and wear of the battery side connector 104 may be detected by the evaluation jig.

It will be appreciated by those skilled in the art that the exemplary embodiments described above are specific examples of the aspects described below.

### Embodiment 1

A vehicle includes
a vehicle body on which a battery is mountable, and
the battery attachable to and detachable from the vehicle body.

The battery includes a battery side connector.

The vehicle body includes a vehicle body side connector to be engaged with the battery side connector.

The battery side connector is made of a material having a lower hardness than a material constituting the vehicle body side connector.

In this vehicle, since the battery side connector is made of a material having a lower hardness than the material constituting the vehicle body side connector, wear of the vehicle body side connector is reduced.

### Embodiment 2

In the vehicle according to Embodiment 1,
the vehicle side connector includes
   a contact portion that contacts the battery side connector, and
   a wear detection terminal disposed inside the contact portion and insulated from the contact portion, and
the wear detection terminal contacts the battery side connector when the contact portion is worn.

In this embodiment, since the wear detection terminal contacts the battery side connector when the contact portion of the vehicle body side connector is worn, the wear of the contact portion can be detected by detecting conduction between the wear detection terminal and the battery side connector.

### Embodiment 3

In the vehicle according to Embodiment 1 or 2,
the battery side connector includes
   a contact portion that contacts the vehicle body side connector, and
   a wear detection terminal disposed inside the contact portion and insulated from the contact portion, and
the wear detection terminal contacts the vehicle body side connector when the contact portion is worn.

In this aspect, since the wear detection terminal contacts the vehicle body side connector when the contact portion of the battery side connector is worn, the wear of the contact portion can be detected by detecting conduction between the wear detection terminal and the vehicle body side connector.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A vehicle comprising:
a vehicle body on which a battery is mountable; and
the battery attachable to and detachable from the vehicle body, wherein
the battery includes a battery side connector,
the vehicle body includes a vehicle body side connector to be engaged with the battery side connector, and
the battery side connector is made of a material having a lower hardness than a material constituting the vehicle body side connector.

2. The vehicle according to claim 1, wherein
the vehicle side connector includes
a contact portion that contacts the battery side connector, and
a wear detection terminal disposed inside the contact portion and insulated from the contact portion, and
the wear detection terminal contacts the battery side connector when the contact portion is worn.

3. The vehicle according to claim 1, wherein
the battery side connector includes
a contact portion that contacts the vehicle body side connector, and
a wear detection terminal disposed inside the contact portion and insulated from the contact portion, and
the wear detection terminal contacts the vehicle body side connector when the contact portion is worn.
